(19) United States
(12) Patent Application Publication
(10) Pub. No.: US 2021/0041331 A1
(43) Pub. Date: Feb. 11, 2021

(54) CUTTING BLADES

(71) Applicant: Crescent Manufacturing Company, Fremont, OH (US)

(72) Inventors: Mike Waleryszak, Fremont, OH (US); Paul Thottathil, New Hyde Park, NY (US); John M. Ryan, Bellmore, NY (US); Purushothaman Kesavan, Franklin Square, NY (US); Satyabrata Mukherjee, Westbury, NY (US)

(21) Appl. No.: 16/939,398

(22) Filed: Jul. 27, 2020

Related U.S. Application Data
(60) Provisional application No. 62/885,024, filed on Aug. 9, 2019.

(51) Int. Cl. G01N 1/06; C09D 5/08; C09D 4/06; C09D 133/04; C09D 127/18

(52) U.S. Cl. CPC G01N 1/06; C09D 5/08; G01N 2001/061; C09D 133/04; C09D 127/18; C09D 4/06

(57) ABSTRACT

This subject technology relates to a polymeric composition for application onto substrates, such as stainless steel blades, for lubricity, abrasion resistance, and corrosion resistance. The coatings developed using the subject technology of chemical grafting in one aspect involves the use of prepolymer, monomers, catalysts, graft initiator, wetting agent, fillers and other ingredients of the composition. The coating thus obtained when applied on the stainless steel allows obtaining graft polymerization, thereby forming a polymer film chemically attached to the substrate. The substrate is reacted with graft initiators which create reaction sites on the substrate via a free radical mechanism that renders the substrate receptive to attachment of monomers/prepolymers, thus forming a polymeric film that is chemically bonded to the substrate to achieve the desired properties in terms abrasion, wear, lubricity and other properties.

### FIELD

The subject technology relates generally to compositions or coatings, and specifically to such compositions for application onto substrates to achieve, for example, lubricity, abrasion resistance, and corrosion resistance.

### BACKGROUND AND SUMMARY

“Grafting” has been historically understood to mean to transplant or to be transplanted from one body to another in such a way that new growth can continue. Similarly, “chemical grafting” as used in one aspect of the subject technology, involves the transplantation of monomers to various substrates to change (e.g. improve) various properties without any basic change to the substrate itself. A proprietary technology has been developed which uses only monomers and prepolymers as grafting components, utilizing novel graft initiators to start and continue the grafting process.

Historically, grafting has been done by using various types of electromechanical and electronic devices and methods (e.g. gamma radiation, X-ray, Corona discharge, and sputtering) which were adequate in some situations. However, such devices eventually became too expensive and/or inadequate.

In order to initiate grafting, one must prepare the surface of the substrate to accept the graft. The graft initiators and chemical activators of the subject technology in one aspect are a purely chemical way of exposing active sites on the surface of the substrate to initiate grafting. In some aspects, application may be done by spraying, dipping or rolling.

The various types of graft initiators of the subject technology permit, by adaptation, myriad monomers and substrate grafting combinations. In one aspect, the surface preparation and grafting are performed in single application within a relatively reasonable time period. Monomers, the building blocks of all polymers, are relatively small in size, and light in molecular weight, and they are much less expensive than polymers. Additionally, pinhole-free coatings are easily obtainable with monomers because the penetration of monomers is much greater than that of any other liquid.

Chemical grafting of chemical bonding may be divided into three basic areas of functional capability. They are: coatings, in depth grafting, and laminating.

### 1. COATINGS

Surface characteristics of a substrate can be drastically changed by applying a coating. Coatings can be used for example to improve the appearance of the substrate, for corrosion protection, for electrical insulation, and for adhering two materials together. Conventional coatings adhere to substrates by physical forces which are problematic in that they can be easily broken. Consequently, peeling or delamination may occur. Chemical grafting of the subject technology avoids these shortcomings since attachment of coatings is accomplished by forming a chemical, covalent bond which allows much thinner coatings that provide extended life and superior adhesion.

Various monomers have been successfully grafted to substrates, such as metals, plastics, rubber, cellulosic materials, liquids and nature formed, living organisms. The chemical reaction that takes place on the surface provides a monomolecular layer of chemically bonded coating, which can be increased in thickness to the desired amount. Results have shown that coatings of one-half ( ½) mil thickness provide up to 2000 hours of salt spray protection.

### 2. IN DEPTH GRAFTING

In some instances, the fine layer of grafted material deposited on the surface of the substrate is not sufficient, and it is therefore necessary for the monomers to penetrate to a certain depth or even throughout the matrix of the substrate to achieve desired performance. For example, to achieve total wettability of plastics (e.g. porous Teflon, nylon), one must be able to chemically graft water absorbing chemicals in depth. Similarly, to obtain permanent flame retardency, one must totally penetrate the textile or a bundle of yarn filaments or even saturated wood. The subject technology provides a tool for the industry so that the molecular chemical grafting can take place under difficult conditions while providing advantageous results.

### 3. LAMINATING

In some applications it is necessary to combine more than one substrate together to form a laminate. Sometimes several layers of various materials are laminated (sandwiched) together to achieve desired characteristics. An off-the-shelf adhesive (e.g. glue) that is normally used for such applications will typically fail under certain conditions, such as when temperature changes occur. Also, the adhesive will fail in shear, when various layers comprising the laminate have different coefficients of thermal expansion. To avoid such failures, the subject technology presents several graft initiators which can be instrumental in grafting difunctional monomers in such a way that one of the carbon-carbon chain will attach itself to one of the substrates at temperature T1 and the other end will follow suit at some higher temperature T2. It is known that carbon-carbon chains are in the form of a helix, which can extend and contract depending on temperature.

The various compositions and methods of the subject technology can be used on substrates such as glass, ribbon, and polypropylene, which have been sandwiched and subjected to thermal shock without showing ill-effects.

To summarize, molecular grafting is a tool for the industry which permits alterations of the properties of substrates inexpensively, with very small dimensionally stable coatings with improved longevity relative to conventional technologies.

The various compositions and methods of the subject technology can be used for protective coatings for leather parts. A method of grafting a protective coating on leather offers advantages relative to scratch resistance, conductivity, ultraviolet (UV) light, and other advantages. For example, protecting leather gloves has heretofore relied on conventional coatings. The subject technology relates to composition for graft polymerizing a protective coating onto leather articles so the protection is sufficiently durable and not readily removed from the substrate.

### CHEMICAL GRAFTING

The idea that a second polymeric species can be attached by a covalent linkage to an existing polymeric material was first suggested in the late 1930s. A substance of this type was first produced in the laboratory in the early 1940's. Since that time, sufficient data has been accumulated about such processes, so that they have gained importance for a variety of industrial applications. This method, where a “foreign” material becomes attached to another material by means of a chemical bond is referred to as “chemical grafting”. One example is the production of acrylonitrile-butadiene-styrene (ABS) resin obtained by the direct attaching of styrene-acrylonitrile on to a polybutadiene backbone. This often is achieved by the polymerization of styrene and acrylonitrile in the presence of butadiene. This process gives the ABS the ability to have impact resistance. The foregoing is sometimes generally referred to as “grafting” or “chemical grafting”, but can be more accurately described as “chemical bonding technology”.

Chemical grafting might be visualized as the growth of “whiskers” onto a material. These whiskers are joined to the substrate by means of chemical bonding. This is in direct contradiction to ordinary coatings where the bond between the substrate and the coatings is only physical in nature. A relatively higher degree of permanency is achievable using chemical grafting.

Chemical grafting involves the activation of the substrate. Once the substrate has been activated, chains of monomers linked by carbon bonds grow on the substrate resulting in the existing positive characteristics of these materials.

In one aspect of the subject technology, the question of pollution is taken into account. Where possible, and this is generally the case, the reactions make use of emulsions or aqueous solutions. Towards this end, the necessary organic materials are solubilized in water. By the time the process is complete, the organic materials are essentially exhausted.

Among the “permanent” properties that can be added are nonflammability, abrasion, abrasion resistance, lubricity, soil repellency, improvement of adhesion-ion exchange, ultraviolet protection, water absorbency, gas impermeability, bactericidal, fungicidal, and many others. The areas of application of the resultant materials include textiles, plastics, pollution control, and biomaterials. In addition to these types of materials, the subject technology incorporates substrates which would not ordinarily be considered as possessing “active hydrogens” such as silicon, metals, and polycarbonate. In the latter situations, sites for attachment are provided where possible by the removal of a hydrogen from the hydroxy form of a tightly bound oxide on the surface of the substrate or by the removal of labile electron which are available from the bulk of the material.

In one aspect, the chemical grafting consists of growing polymer chains on a backbone chain of a substrate. The grafted polymer chains are formed from vinyl monomers or monomers containing appropriate functionality (e.g. acrylate, methacrylate, hydroxyl, carboxyl, epoxy, urethane, amide, amine, anhydride).

### MECHANISM

Many materials, both naturally occurring and synthetic, possess hydrogen which are more reactive than the “bulk hydrogens”, for example, the tertiary hydrogen in polypropylene I, the amide hydrogen in proteins II and hydroxyl hydrogen n polysaccharides III.

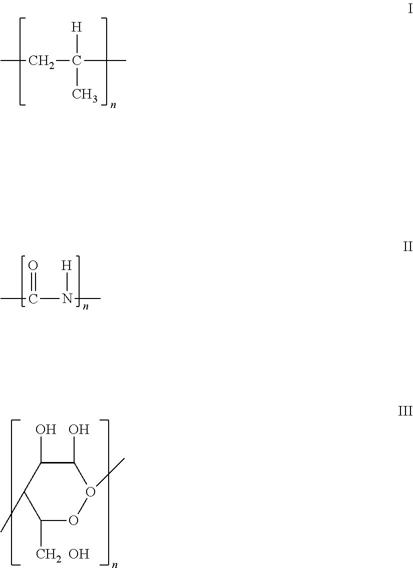

In one aspect, a novel chemical activator (C.A.) has the capacity of removing active hydrogens and concomitantly initiating the growth of polymer chains at the site from where the active hydrogen was removed. In the case of polypropylene, this can be represented as follows:

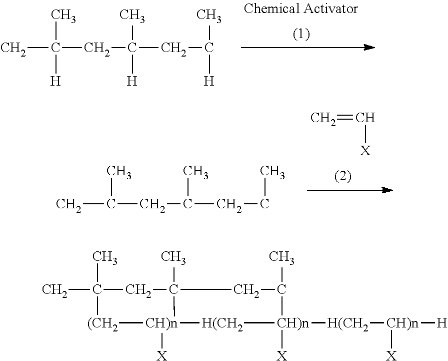

In addition to the foregoing types of materials, the subject technology involves substrates which ordinarily would not be considered as possessing “active hydrogens” such as silicon, metals, polycarbonate, etc. In the latter situations, sites for attachment are provided, where possible, by the removal of a hydrogen from the substrate or by the removal of liable electrons which are available from the bulk of the material.

### GENERAL MECHANISM FOR GRAFTING ONTO A SUBSTRATE

In one aspect, the chemical grafting consists of growing polymer chains on a backbone chain of a substrate. The graft polymer chains are formed from vinyl monomers containing appropriate functionality (e.g. groups such as hydroxyl, carboxyl, epoxy, amide, amine, anhydride). The series of steps involved in the mechanism of chemical grafting to produce grafted polymer chains on the vinyl substrate is represented below:

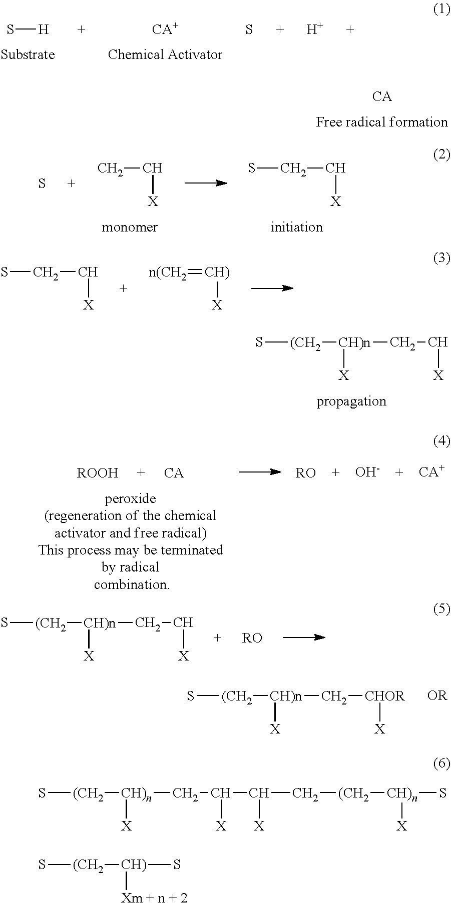

Reaction 6 especially should give a chemical bridge between the substrates. The side functional group X could be chosen such that their further interaction with the substrate shall result into desired properties, e.g. adhesion, barrier properties, and other characteristics.

The graft initiator ion starts the action and the whole process behaves like an anticatalytic one. A small amount of graft initiator ion (5 to 10 ppm) is therefore sufficient to carry out the process of graft polymerization. All of the foregoing reactions take place in the presence of peroxide which concurrently regenerates the graft initiator forming a free radical.

GI+ROOH→RO+OH⁻+GI⁺

In the case of polyester, it is presumed the reaction takes in the following way:

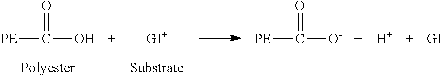

The free radical carbonyl group thereafter reacts with either a first component or a second component. e.g.:

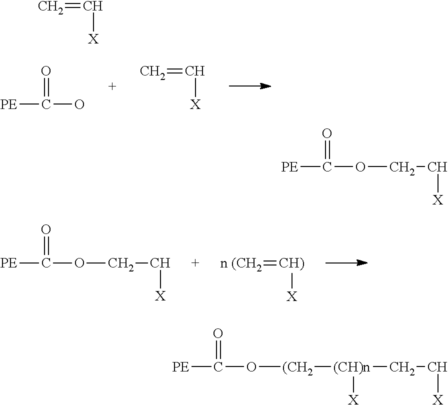

The process may be terminated by radical combination.

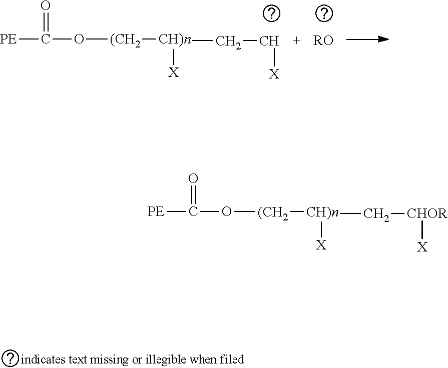

In one aspect, a graft-initiator (G.I.) has the capacity of removing active hydrogens and concomitantly initiating the growth of polymer chains at the site from where the active hydrogen was removed. In the case of polypropylene, this can be represented as follows:

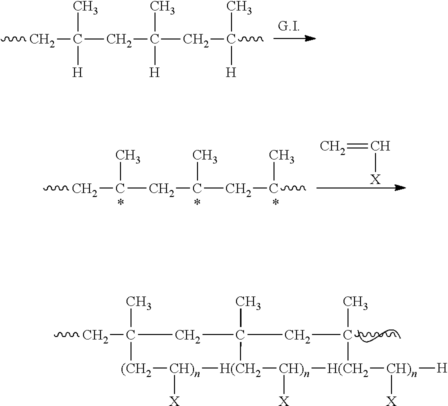

Where * can represent either a free radical, anion or cation, depending on whether the G.I. removes a hydrogen and one electron, no electrons or two electrons, respectively. There are a wide variety of monomers which do not lend themselves to the free-radical type of polymerization. The fact that all three mechanisms can be used widely broadens the scope of application of this method. The following represents a unit of vinyl monomer:

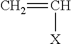

Where “X” governs the property or properties that are obtained. In many instances, a mixture of monomers is employed and often more than one property can be altered in one processing step. These polymer chains, whose length can be controlled, are permanently attached to the “substrate”. The linkage between the graft-polymer and the substrate is covalent in nature, therefore, the graft-polymer cannot be leached from the substrate.

In this description, graft-initiation is portrayed as being separate and distinct from the subsequent graft-polymerization. For some applications this is the true picture. However, for a majority of the uses these steps can be combined since the graft initiators possess sufficient selectivity such that almost no homopolymer is encountered. This is true for the situation where the desired end result could be obtained by the attachment of a commercially available vinyl monomer. But there are cases where such a monomer is not available or where it might be advantageous to have a substance relatively loosely bonded (so as not to inactivate a functional group or destroy a particular conformation) or where a substance is to be released over an extended period of time (e.g. for sustained-release drug delivery system, biomaterials). Three approaches are possible for this type of situation: covalent linkage, electrostatic bond, and hydrogels.

### A. Through a Covalent Linkage

Monomers of the acrylic acid type can supply a “handle” which allows for the attachment of the desired species to a substrate. If the species contains a hydroxyl group (either alcoholic or phenolic—A-OH),

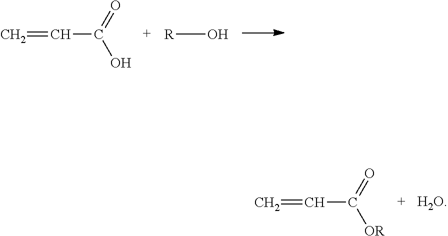

However, if it contains an amino group (R—NHR′),

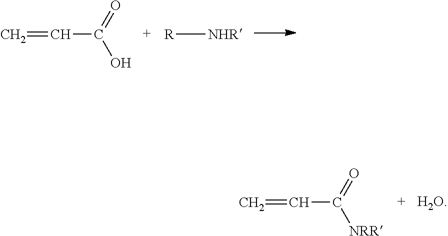

Finally, if it contains a carboxyl group

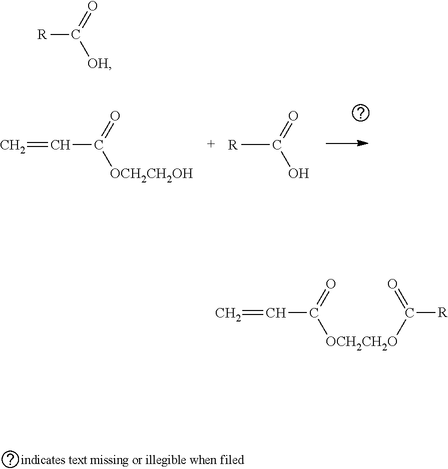

The rate of release of the desired species is governed by the kinetics for hydrolysis of classical esters and amides.

### B. Through an Electrostatic Bond

Permanent positive or negative charges can be introduced onto substrates by the use of monomers which contain permanent positive or negative charges.

### a. Positive Charges

Many examples of quaternary-nitrogen-containing vinyl monomers are known or are readily available, e.g. benzyl 2-methyl-5-vinylpyridinium chloride,

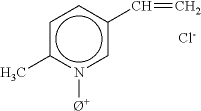

Substitution on the pyridine ring in various positions with both electron-donating and electron-accepting groups would provide for a series of vinyl monomers with a variety of strengths of positive charge. Another family could be obtained from vinyl anilinium salts,

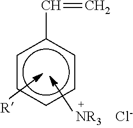

### b. Negative Charges

Families of vinyl monomers which contain salts of acids are known or may be readily synthesized, e.g., the vinyl benezenesulfonic acids:

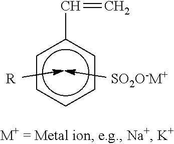

When permanently attached to a substrate, these monomers result in a permanently negatively charged surface.

In these instances, if the desired species has any positive or negative polarity whatsoever, it can be attached to a substrate of opposite polarity. Also, the judicious selection of the polar monomer attached to the substrate would allow for different strengths of attachment and therefore subsequent release, should this be desirable.

### C. Through Hydrogels Introduced onto Various Materials

Hydrogels generally fall into two categories: hydroxyalkyl derivatives of acrylic or methacrylic acid and acryl-amides. These highly swollen hydrogels are quite weak physically and generally it is advantageous to chemically graft them onto a substrate. The desired species are held to the hydrogel by Van der Waals forces. Thus, the activity of an enzyme for example can be maintained in this type of system because both its active site and its conformation is unaltered. Release of the desired species is diffusion controlled.

Examples: a few specific applications of this chemical grafting technology are provided below.

Fiberglass. Fiberglass fabric to be used for decorative purpose such as drapery, has several deficiencies:
a. Poor abrasion resistance. This is manifest by the coarseness to feel of untreated fiberglass fabrics.
b. Causes skin irritation.
c. Requires sizing.
d. Lack of desirable dyeability (i.e. does not withstand several washings in a washing machine)

The subject technology is readily adaptable to the existing production situation for fiberglass (equipment, speeds, time, etc) which increased the abrasion resistance fourfold, provides for dyeability for the life of the fabric, allows for the maintenance of weave (without unraveling) even of very sheer fiberglass fabric and no skin sensitization problems are encountered.

Human tooth. One of the theories for the occurrence of dental cavities is that tooth decay arises from dental plaque which in turn is caused by bacteria. Therefore, if one could attach a bacteriostatic agent “permanently” to the tooth, tooth decay might be prevented.

A chemical grafting system has been developed whose components are nontoxic and nonallergenic. Difunctional monomers have been found that on the one hand attach themselves to the tooth's surface and on the other hand to known safe quaternary-nitrogen-containing bacteriostatic agents. Attachment is to the tooth at the exclusion of the gums. In addition, systems have been found that specifically attach themselves to the crown of the tooth and not the root, and vice versa.

In vitro experiments have shown that the bacteriostat, applied in this fashion, is not removed after numerous washings. Attachment is achieved by rinsing in the mouth with warm water for thirty to sixty seconds. Thus, it may be used in a mouthwash or toothpaste.

Metalization of plastics. The difficulty with metallizing plastics electrochemically arises from the nonconductivity of the plastic. This problem is obviated by depositing a thin layer of copper on the surface. Once this has been achieved, other metals can then be deposited by standard methods.

At present, the deposition of the initial thin copper layer is a ten to twelve step process involving the use of expensive palladium compounds and causing pollution problems due to the use of reagents such as sulfuric and chromic acids and stannous chloride.

For various plastics (including polyolefin, ABS, polyphenylene oxide and polyurethane foam), chemical grafting has been able to reduce the initial copper deposition to two steps (the first step being etching) or one step processes. The plastic part is introduced into a grafting solution, cured, and then introduced into an electroless copper solution. The resulting part, possessing a matte copper finish, is then amenable to subsequent deposition of other metallic finishes such as bright copper, nickel, chrome, etc, in their proper sequence. The adhesion, at a minimum, is as good as for existing process methods if not better. It is unaffected by thermocycling. One can even simulate gold without using gold-containing compounds.

Another method of metal deposition on plastics, for metals such as aluminum, utilizes vapor deposition methods. However, the adhesion and the brightness of the metallic surface is generally poor. A chemically grafted coating has been developed that markedly improves the adhesion and the brightness for vapor-deposited metals.

Finally, clear protective coatings have been developed to protect the metallized surface from oxidation.

Wettability of hydrophobic plastics. Polypropylene is relatively cheap and nonreactive. However, there are a number of applications for which it cannot be used because of its hydrophobicity. For example, nonwoven polypropylene might find application as a battery separator if it were rendered permanently wettable, wickable, and stable in sulfuric acid.

A process has been developed which renders nonwoven polypropylene wettable and wickable. In addition, the wettability of the resulting material is unaffected when the treated material is maintained in 40% sulfuric acid for ninety minutes then under running water for ninety minutes and finally dried at 230 deg F for ninety minutes.

In addition, Teflon, whose nonwettability and lack of chemical reactivity are well known, has been rendered wettable both as a finished film and as a woven fabric. As a matter of fact, it has been found possible to make one side of a Teflon film completely wettable whereas the other side of the film is unaffected.

Membranes. Chemical grafting, which allows for the tailoring of materials, has found application for a variety of techniques which might be categorized as membrane processes e.g. reverse osmosis, electrodialysis, battery separators, etc. For example, cellulose acetate membranes provide excellent water purification when used in reverse osmosis apparati. One of the drawbacks is that the flow of the water over these membranes is rather slow.

Empirically, after trying numerous monomers, it was found that by permanently affixing either positive or negative groups, one can increase the flow three-fold, without deleteriously affecting the water purification property. In addition, it was found that one could conduct the chemical grafting on the cellulose acetate in solution (in DMF) before one casts the membrane or on the finished membrane and the same results are obtained. This substantiates the fact, that a least in this case, one can chemically graft onto solutions.

Flammability. Some aspects of the subject technology find use relating to flame retardancy in the textile industry. By the use of combinations of monomers rich in phosphorous, nitrogen, bromine and/or chlorine, durable flame-retardancy has been obtained in fabrics such as cotton, cotton-polyester, nylon, etc. Flame retardance, unaffected by numerous launderings and dry cleaning, is attainable. Of late, this concept has been extended to nonwoven polypropylene (for carpet backing). The treated polypropylene fabric does not ignite even after launderings and dry cleaning.

Vapor Barriers. Among the reasons why plastics have not found their place as a replacement for glass in the bottling industry is due to the poor vapor barrier characteristics of the plastics toward a variety of compositions which they are required to retain. Finished polyolefin containers have been chemically grafted using the subject technology so as to decrease the permeability of aromatic compounds of pharmaceutical interest (such as menthol, oil of wintergreen, etc.). Such permeability has been decreased 80% at elevated temperatures. Another system has been found that decreases the permeation of oxygen and peroxide for the use of polyolefin in certain aerosol containers.

Method of preparation of formulation. In one aspect of the subject technology, a requisite amount of precalculated quantity of epoxy prepolymer, phenolic prepolymer, melamine prepolymer, pigments, coupling agents, thickness agents, solvents, monomers, surfactants, catalyst and graft initiators are taken in a container. Some of the ingredients are milled on a milling machine to make them homogeneous. The coating solution thus prepared is ready for application on stainless-steel blades.

Substrates coated using conventional techniques suffer from various shortcomings. For example, such coatings adhere to the substrate through only physical bonds. Such coatings are problematic in that they can be dislodged from the substrate over a relatively shorter period of time as moisture, oxygen, corrosive gases, and other environmental conditions compromise the physically bonded substrate. Thus, there is a need for an improved coating for substrates having improved characteristics, including those of bonding, lubricity, hardness, abrasion resistance, and corrosion resistance.

Additionally, conventional microtome blades have apertures (aka holes). However, such holes are problematic because the strength and deflection characteristics of the blade are compromised by the holes. It is therefore desirable to mitigate those and other problems apparent to those of skill in the art, by utilizing blades devoid of any such apertures.

In one aspect, the stainless-steel blade is devoid of an aperture formed therein. As shown in FIG. 5, the first blade 1 has two apertures 4, whereas second and third blades 2, 3, respectively, are devoid of an aperture. As shown, apertures 4 in one aspect are elongated ovoid, holes disposed entirely through the blade.

In one aspect of the subject technology, a graft coating formulation is applied to stainless steel blades having superior lubricity, chemical, water, and corrosion resistance. The subject technology in one aspect is based on covering the blades with a protective coating by chemically grafting organic monomers and prepolymers thereto, thereby forming a strongly bonded coating on the metal substrate. The monomers and prepolymers are so selected that the polymer film grafted onto the metal has excellent chemical and corrosion resistance.

In one aspect, the polyfunctional monomers and prepolymers are used. In one aspect, the polyfunctional monomers and prepolymers are vinyl monomers, methacrylate monomers, epoxy prepolymers, phenolic prepolymers, acrylic prepolymers, and fluoropolymers, which are chemically bonded to the metal substrate via hydroxyl hydrogen of the metal hydroxide. In one aspect, the monomers are preferably vinyl, epoxy, acrylic, vinyl, or urethane having one or more hydroxyl, carboxyl or epoxy or glycidyl group.

One object of the subject technology is to provide a composition that is adhered to a substrate by chemical grafting and/or covalent bonding.

One object of the subject technology is to provide a composition that is adhered to a stainless-steel microtome blade by chemical grafting and/or covalent bonding.

One object of the subject technology is to provide a composition that is adhered to a stainless-steel microtome blade devoid of any apertures, by chemical grafting and/or covalent bonding.

One object of the subject technology is to provide a composition that has desirable characteristics in terms of lubricity and hardness.

One object of the subject technology is to provide a composition that has desirable characteristics in terms of lubricity, abrasion resistance, and corrosion resistance.

In one aspect of the subject technology, the coating formulation is applied by dipping, spraying or any other conventional method. The coated metal parts are air dried for 10 to 15 minutes and subjected to cure at 170° C. for 30 minutes. The coated and cured samples can then be subjected to testing to confirm desired characteristics. Different aspects are shown in FIGS. 1 through 4 wherein it should be understood that EEP is equivalent to Ethyl 3 Ethoxy propionate.

In one aspect of the subject technology, “coated blades” are produced that exhibit improved physical properties wherein the applied polymer coating is better able to withstand abrasion, chemical resistance, and has better lubricity.

The resulting coating layer admixture of the prepolymer and monomer can be varied depending on how far the reaction is carried out. In one aspect, a composition is applied to a substrate, the composition comprising solvents, a graft initiator for activation, a catalyst for activating or regenerating the graft initiator, and a first component that has a functional group for reaction and covalent bonding with an active site for the substrate. In one aspect, a dispersible polymer is used such as for example an epoxy prepolymer, phenolic prepolymer and fluoro prepolymer.

In one aspect, components comprise at least dispersible polymer which includes at least one functional group (e.g. carboxyl, epoxy, hydroxyl, amino melamine or acrylic group). These polymers are ideally suited for incorporation into grafting solutions and have sufficient graft segments so as to have a highly flexible graft polymer.

In one aspect, the monomer used in one or more of the compositions of the subject technology described herein comprises acrylate, vinyl, epoxide metharylate or acrylic.

In one aspect, the coating must be inert to chemicals, impermeable to air, oxygen, and moisture and also impervious to the passage of ions and electrons of the solvents, and have good adhesion. Such coatings prevent abrasion by suppressing the process and chemical graft is superior to ordinary coatings and gives household chemicals and corrosion resistance.

In one aspect, the monomer used in one or more of the compositions of the subject technology described herein comprises acrylic, vinyl, and epoxy monomers having functional grouping such as carboxyl, hydroxyl, amino, and ester.

In one aspect, the graft initiator used in one or more of the compositions of the subject technology described herein comprises a metallic salt. In one aspect, the graft initiator used in one or more of the compositions of the subject technology described herein comprises one or more of silver nitrate, silver perchlorate, ferrous ammonium sulfate, silver acetate, and copper acetate.

In one aspect, graft initiators are used in small quantities in order to ionize the metal salt to provide an activating metal ion. In one aspect, the graft solution includes a catalyst.

In one aspect, the catalyst used in one or more of the compositions of the subject technology described herein comprises peroxide. In one aspect, the catalyst used in one or more of the compositions of the subject technology described herein comprises peroxides of urea, hydrogen, benzoyl or methyl. The catalyst functions to ionize metal salts into silver iron or any other metal as graft initiator.

In one aspect, the subject technology relates to a chemical resistant and corrosion resistant graft coating used in the manufacturing of stainless steel blades.

In one aspect, the subject technology relates to a polymeric composition for application onto stainless steel blades for lubricity, abrasion resistance, and corrosion resistance. Usually such blades do not have lubricity and abrasion resistance. The coatings developed using the subject technology of chemical grafting in one aspect involves the use of prepolymer, monomers, catalysts, graft initiator, wetting agent, fillers and other ingredients of the composition. The coating thus obtained when applied on the stainless steel allows obtaining graft polymerization, thereby forming a polymer film chemically attached to the substrate. The stainless steel substrate is reacted with graft initiators which create reaction sites on the substrate via a free radical mechanism that renders the substrate receptive to attachment of monomers/prepolymers, thus forming a polymeric film that is chemically bonded to the substrate to achieve the desired properties in terms abrasion, wear, lubricity and other properties as will be apparent to those of skill in the art after studying the subject technology.

In one aspect, a composition comprises water, a flouro-chemical, a flouro-monomer, a graft initiator, a prepolymer, a wetting agent, an additive for adding hardness, one or more catalysts, one or more monomers, one or more solvents, and one or more surfactants.

In one aspect, a composition comprises water, a flouro-chemical, a graft initiator, a monomer, a prepolymer, a surfactant, a wetting agent, one or more catalysts, one or more flouro-monomers, and one or more solvents.

In one aspect, a composition comprises water, a flouro-chemical, a graft initiator, a prepolymer, a wetting agent, one or more catalysts, one or more monomers, one or more solvents, and one or more surfactants.

In the various aspects of the subject technology as described herein, various constituents can be grouped in different ways, or alternatively not grouped at all, and that the constituents can be mixed in different orders, and that milling, or mixing, of any of the groups, or other groupings, can be performed, and that such compositions thereby formed can be applied to various substrates, with or without curing, all of the foregoing achieving varying compositions and varying results, with varying characteristics.

In some aspects of the subject technology as described herein, the compositions of the subject technology are applied to a portion of a stainless-steel blade. The various compositions of the subject technology can be applied to such blades by dipping, spraying, or other methods provided the composition is not undesirably affected by such other method.

### BRIEF DESCRIPTION OF THE DRAWINGS

FIG. 1 Depicts a table of constituents in one aspect of the subject technology.

FIG. 2 Depicts another table of constituents in one aspect of the subject technology.

FIG. 3 Depicts another table of constituents in one aspect of the subject technology.

FIG. 4 Depicts another table of constituents in one aspect of the subject technology.

FIG. 5 Depicts several blades.

### DETAILED DESCRIPTION

In one aspect of the subject technology, a method of forming a composition comprises the steps of: combining a first group of constituents; then combining the first group of constituents with a second group of constituents; and then combining the combined first and second group of constituents with a third group of constituents to form the composition.

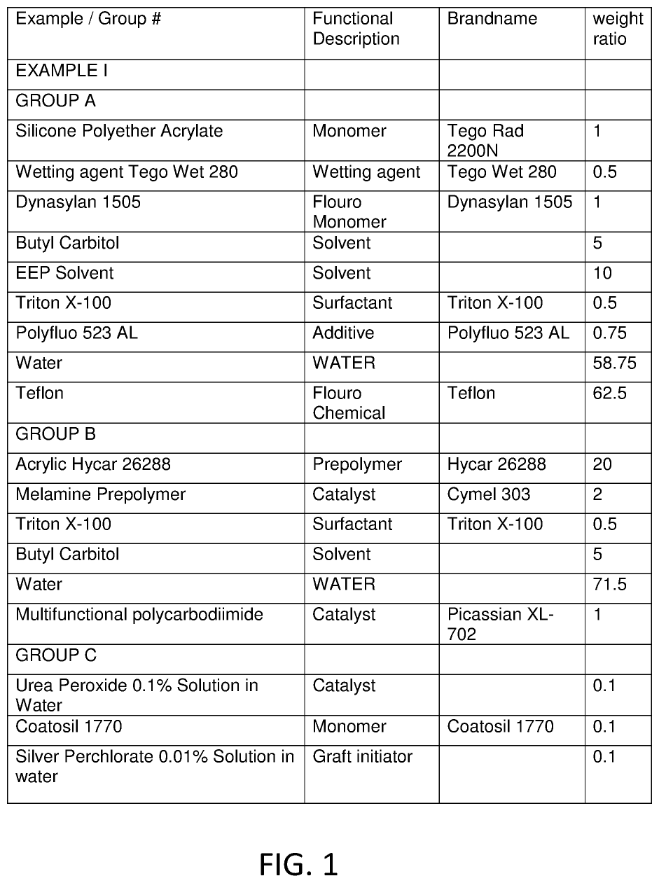

FIGS. 1 through 4 each depict a table of constituents grouped into A, B, & C groups. It is to be understood that the constituents of FIGS. 1 through 4 can be grouped in different ways, or alternatively not grouped at all, and that the constituents can be mixed in different orders, and that milling, or mixing, of any of the A, B, & C groups, or other groupings, can be performed, and that such compositions thereby formed can be applied to various substrates, with or without curing, all of the foregoing achieving varying compositions and varying results, with varying characteristics.

In one aspect, for any one of FIGS. 1 through 4, the constituents of the A group are first mixed together, then the constituents of the B group are added to the A group, and the combination of the A & B group are then mixed, then the constituents of the C group are added to the combination of the A & B group and mixed.

In one aspect, for any one of FIGS. 1 through 4, the constituents of the A group are mixed together, and the constituents of the B group are first mixed together and then added to the A group, and then the combination is mixed; then the constituents of the C group are first mixed together and then added to the combination of the A and B groups, and then the combination is mixed.

In one aspect, for any one of FIGS. 1 through 4, one or more of the first, second, and third group of constituents, or the combination of the first and second group of constituents, or the third group of constituents combined with the combined first and second group of constituents, are milled on a milling machine to make them homogeneous.

In one aspect, for any one of FIGS. 1 through 4, the constituents of each of FIGS. 1 through 4 are combined without regard to the A, B, & C groupings of each table.

In one aspect (FIGS. 1 & 4), the first group of constituents consists of, a monomer, a wetting agent, a flouro-monomer, a first solvent, a second solvent, a surfactant, an additive (e.g. an additive for adding hardness), water, and a flouro-chemical; the second group of constituents consists of, a prepolymer, a first catalyst, a surfactant, a solvent, water, and a second catalyst; and the third group of constituents consists of, a catalyst, a monomer, and a graft initiator.

In one aspect, the monomers described herein comprise acrylate, vinyl, epoxide metharylate or acrylic. In another aspect, the monomers described herein comprise acrylic, vinyl, and epoxy monomers having functional grouping such as carboxyl, hydroxyl, amino, and ester.

In one aspect, the catalysts described herein comprise peroxides. In other aspects, the catalysts described herein comprise peroxides of urea, hydrogen, benzoyl or methyl.

In one aspect, the graft initiators described herein comprise metallic salts. In another aspect, the graft initiators described herein comprise silver nitrate, silver perchlorate, ferrous ammonium sulfate, silver acetate, and copper acetate.

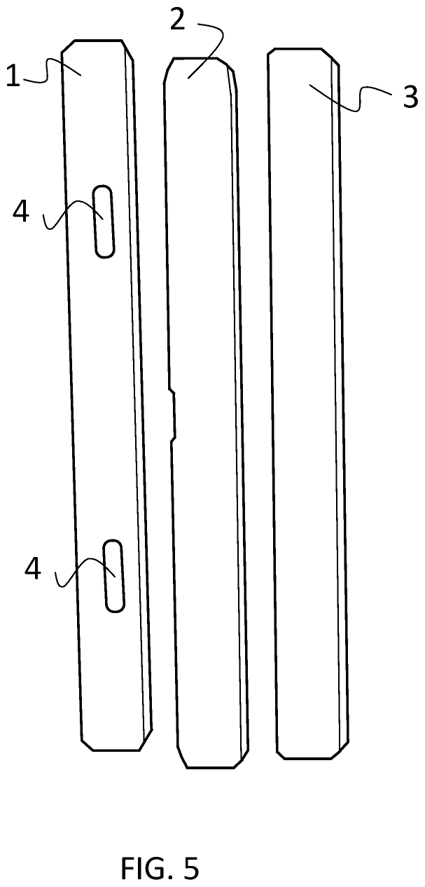

In one aspect, the compositions of the subject technology are applied to a portion of a stainless-steel blade. FIG. 5 depicts several blades 1, 2, & 3. The various compositions of the subject technology can be applied to such blades by dipping, spraying, or other methods provided the composition is not undesirably affected by such other method.

In one aspect, a method of the subject technology comprises the step of: first air-drying the stainless-steel blade having one or more of the various compositions of the subject technology as described herein applied thereon for 10 to 15 minutes, and then curing the stainless-steel blade having one or more of the various compositions of the subject technology as described herein applied thereon at 170 degrees Celsius for 30 minutes.

In one aspect, the stainless-steel blade is devoid of an aperture formed therein. As shown in FIG. 5, the first blade 1 has two apertures 4, whereas second and third blades 2, 3, respectively, are devoid of an aperture. As shown, apertures 4 in one aspect are elongated ovoid, holes disposed entirely through the blade. Unfortunately, such holes weaken the blade and have other undesirable effects, such as, for example, undesirable blade deflection characteristics. It is therefore desirable to mitigate those and other problems apparent to those of skill in the art, by utilizing blades devoid of any such apertures.

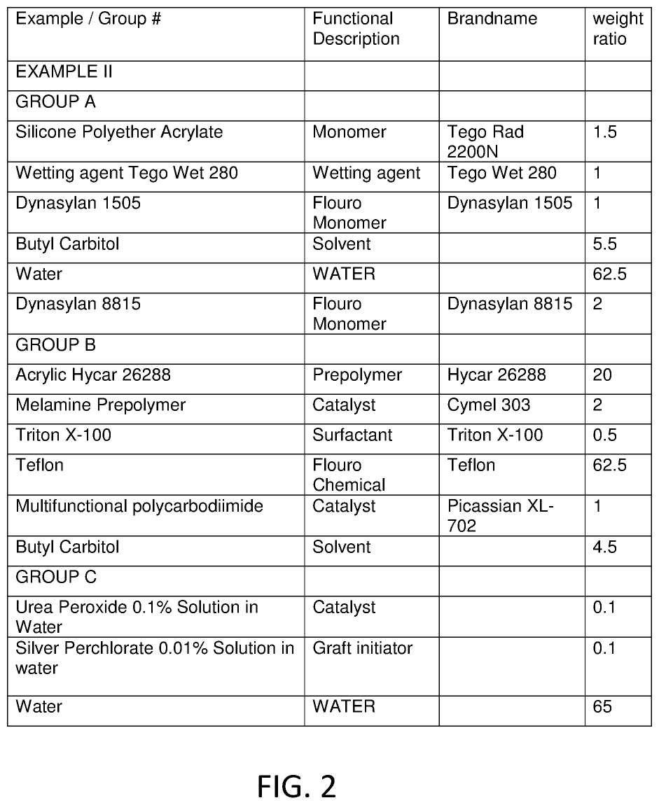

In one aspect (FIG. 2), the first group of constituents consists of, a monomer, a wetting agent, a first flouro-monomer, a solvent, water, and a second flouro-monomer; the second group of constituents consists of, a prepolymer, a first catalyst, a surfactant, a flouro-chemical, a second catalyst, and a solvent; and the third group of constituents consists of, a catalyst, a graft initiator, and water.

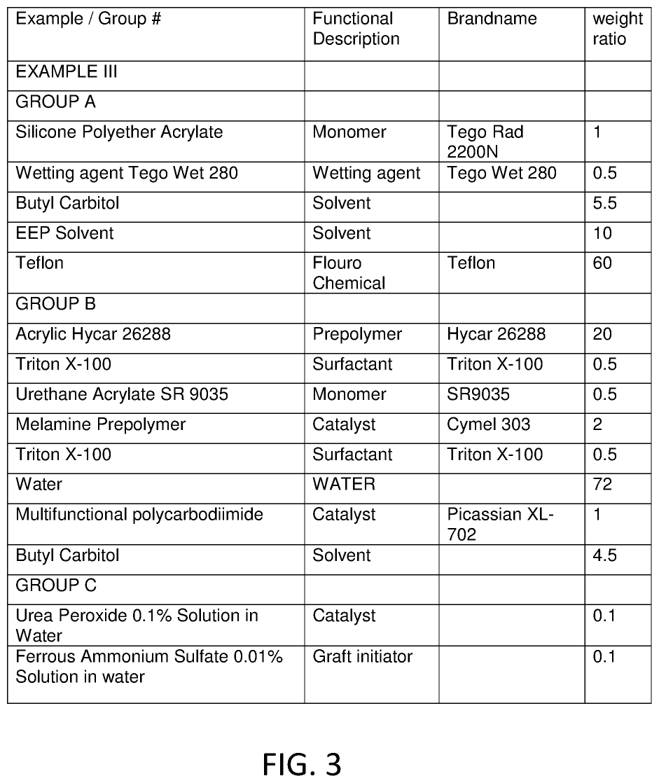

In one aspect (FIG. 3), the first group of constituents consists of, a monomer, a wetting agent, a first solvent, a second solvent, and a flouro-chemical; the second group of constituents consists of, a prepolymer, a first surfactant, a monomer, a first catalyst, a second surfactant, water, a second catalyst, and a solvent; and the third group of constituents consists of, a catalyst, and a graft initiator.

In one aspect (FIGS. 1 & 4), the first group of constituents consists of, 1 parts by weight of a monomer, 0.5 parts by weight of a wetting agent, 1 parts by weight of a flouro-monomer, 5 parts by weight of a first solvent, 10 parts by weight of a second solvent, 0.5 parts by weight of a surfactant, 0.75 parts by weight of an additive (e.g. an additive for adding hardness), 58.75 parts by weight of water, and 62.5 parts by weight of a flouro-chemical; the second group of constituents consists of, 20 parts by weight of a prepolymer, 2 parts by weight of a first catalyst, 0.5 parts by weight of a surfactant, 5 parts by weight of a solvent, 71.5 parts by weight of water, and 1 parts by weight of a second catalyst; and the third group of constituents consists of, 0.1 parts by weight of a catalyst, 0.1 parts by weight of a monomer, and 0.1 parts by weight of a graft initiator.

In one aspect (FIG. 2), the first group of constituents consists of, 1.5 parts by weight of a monomer, 1 parts by weight of a wetting agent, 1 parts by weight of a first flouro-monomer, 5.5 parts by weight of a solvent, 62.5 parts by weight of water, and 2 parts by weight of a second flouro-monomer; the second group of constituents consists of, 20 parts by weight of a prepolymer, 2 parts by weight of a first catalyst, 0.5 parts by weight of a surfactant, 62.5 parts by weight of a flouro-chemical, 1 parts by weight of a second catalyst, and 4.5 parts by weight of a solvent; and the third group of constituents consists of, 0.1 parts by weight of a catalyst, 0.1 parts by weight of a graft initiator, and 65 parts by weight of water.

In one aspect (FIG. 3), the first group of constituents consists of, 1 parts by weight of a monomer, 0.5 parts by weight of a wetting agent, 5.5 parts by weight of a first solvent, 10 parts by weight of a second solvent, and 60 parts by weight of a flouro-chemical; the second group of constituents consists of, 20 parts by weight of a prepolymer, 0.5 parts by weight of a first surfactant, 0.5 parts by weight of a monomer, 2 parts by weight of a first catalyst, 0.5 parts by weight of a second surfactant, 72 parts by weight of water, 1 parts by weight of a second catalyst, and 4.5 parts by weight of a solvent; and the third group of constituents consists of, 0.1 parts by weight of a catalyst, and 0.1 parts by weight of a graft initiator.

In one aspect (FIG. 1), the first group of constituents consists of, 1 parts by weight of Silicone Polyether Acrylate, 0.5 parts by weight of Tego Wet 280, 1 parts by weight of Dynasylan 1505, 5 parts by weight of Butyl Carbitol, 10 parts by weight of EEP Solvent, 0.5 parts by weight of Triton X-100, 0.75 parts by weight of Polyfluo 523 AL, 58.75 parts by weight of water, and 62.5 parts by weight of Polytetrafluoroethylene (aka Teflon); the second group of constituents consists of, 20 parts by weight of Hycar 26288, 2 parts by weight of Melamine Prepolymer, 0.5 parts by weight of Triton X-100, 5 parts by weight of Butyl Carbitol, 71.5 parts by weight of water, and 1 parts by weight of Multifunctional polycarbodiimide; and the third group of constituents consists of, 0.1 parts by weight of Urea Peroxide 0.1% Solution in water, 0.1 parts by weight of Coatosil 1770, and 0.1 parts by weight of Silver Perchlorate 0.01% Solution in water.

In one aspect (FIG. 2), the first group of constituents consists of, 1.5 parts by weight of Silicone Polyether Acrylate, 1 parts by weight of Tego Wet 280, 1 parts by weight of Dynasylan 1505, 5.5 parts by weight of Butyl Carbitol, 62.5 parts by weight of water, and 2 parts by weight of Dynasylan 8815; the second group of constituents consists of, 20 parts by weight of Hycar 26288, 2 parts by weight of Melamine Prepolymer, 0.5 parts by weight of Triton X-100, 62.5 parts by weight of Polytetrafluoroethylene, 1 parts by weight of Multifunctional polycarbodiimide, and 4.5 parts by weight of Butyl Carbitol; and the third group of constituents consists of, 0.1 parts by weight of Urea Peroxide 0.1% Solution in water, 0.1 parts by weight of Silver Perchlorate 0.01% Solution in water, and 65 parts by weight of water.

In one aspect (FIG. 3), the first group of constituents consists of, 1 parts by weight of Silicone Polyether Acrylate, 0.5 parts by weight of Tego Wet 280, 5.5 parts by weight of Butyl Carbitol, 10 parts by weight of EEP Solvent, and 60 parts by weight of Polytetrafluoroethylene; the second group of constituents consists of, 20 parts by weight of Hycar 26288, 0.5 parts by weight of Triton X-100, 0.5 parts by weight of Urethane Acrylate SR 9035, 2 parts by weight of Melamine Prepolymer, 0.5 parts by weight of Triton X-100, 72 parts by weight of water, 1 parts by weight of Multifunctional polycarbodiimide, and 4.5 parts by weight of Butyl Carbitol; and the third group of constituents consists of, 0.1 parts by weight of Urea Peroxide 0.1% Solution in Water, and 0.1 parts by weight of Ferrous Ammonium Sulfate 0.01% Solution in water.

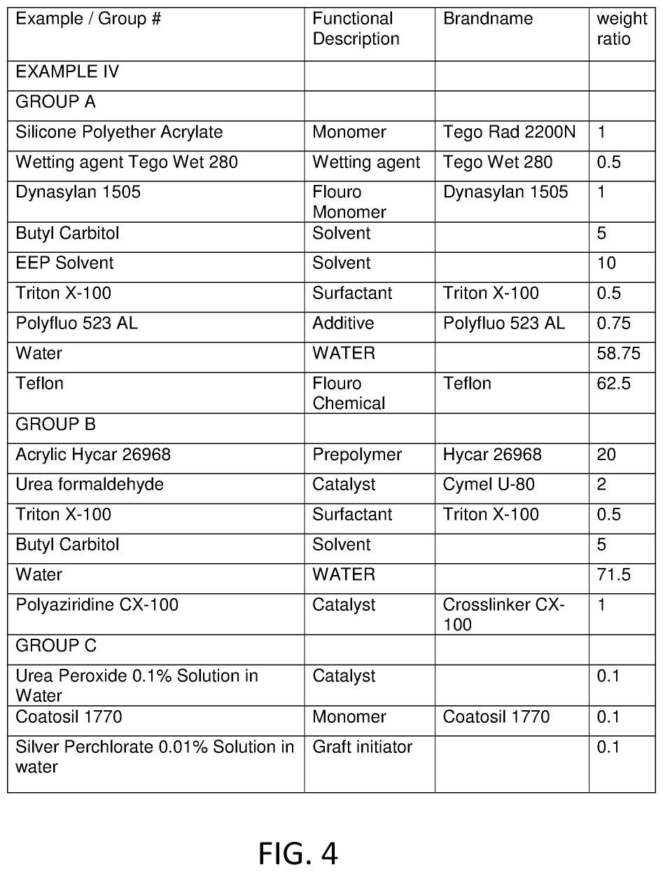

In one aspect (FIG. 4), the first group of constituents consists of, 1 parts by weight of Silicone Polyether Acrylate, 0.5 parts by weight of Tego Wet 280, 1 parts by weight of Dynasylan 1505, 5 parts by weight of Butyl Carbitol, 10 parts by weight of EEP Solvent, 0.5 parts by weight of Triton X-100, 0.75 parts by weight of Polyfluo 523 AL, 58.75 parts by weight of water, and 62.5 parts by weight of Polytetrafluoroethylene; the second group of constituents consists of, 20 parts by weight of Hycar 26968, 2 parts by weight of Urea Formaldehyde, 0.5 parts by weight of Triton X-100, 5 parts by weight of Butyl Carbitol, 71.5 parts by weight of water, and 1 parts by weight of Polyaziridine CX-100; and the third group of constituents consists of, 0.1 parts by weight of Urea Peroxide 0.1% Solution in water, 0.1 parts by weight of Coatosil 1770, and 0.1 parts by weight of Silver Perchlorate 0.01% Solution in water.

In one aspect, a composition is applied to a substrate (e.g. stainless-steel blade), the composition comprising an epoxy prepolymer, a phenolic prepolymer, a melamine prepolymer, a pigment, a coupling agent, a thickness agent, a solvent, a monomer, a surfactant, a catalyst, and a graft initiator.

In one aspect, the monomer used in one or more of the compositions of the subject technology described herein comprises acrylate, vinyl, epoxide metharylate or acrylic. In one aspect, the monomer used in one or more of the compositions of the subject technology described herein comprises acrylic, vinyl, and epoxy monomers having functional grouping such as carboxyl, hydroxyl, amino, and ester.

In one aspect, the catalyst used in one or more of the compositions of the subject technology described herein comprises peroxide. In one aspect, the catalyst used in one or more of the compositions of the subject technology described herein comprises peroxides of urea, hydrogen, benzoyl or methyl.

In one aspect, the graft initiator used in one or more of the compositions of the subject technology described herein comprises a metallic salt. In one aspect, the graft initiator used in one or more of the compositions of the subject technology described herein comprises one or more of silver nitrate, silver perchlorate, ferrous ammonium sulfate, silver acetate, and copper acetate.

In one aspect, a composition is applied to a substrate, the composition comprising solvents, a graft initiator for activation, a catalyst for activating or regenerating the graft initiator, and a first component that has a functional group for reaction and covalent bonding with an active site for the substrate.

In one aspect, the first component is a dispersible polymer. In one aspect, the dispersible polymer includes at least one functional group (e.g. carboxyl, epoxy, hydroxyl, amino melamine or acrylic). In one aspect, the first component is an epoxy prepolymer, phenolic prepolymer or fluoro prepolymer.

In one aspect, a composition is applied to a substrate, the composition comprising prepolymer, monomers, catalysts, graft initiator, wetting agent, fillers and other ingredients.

The invention is in no way limited to the specifics of any particular embodiments and examples disclosed herein. For example, the terms “aspect,” “example,” “preferably,” “alternatively,” and the like denote features that may be preferable but not essential to include in some embodiments of the invention. In addition, details illustrated or disclosed with respect to any one aspect of the invention may be used with other aspects of the invention. Additional elements and/or steps may be added to various aspects of the invention and/or some disclosed elements and/or steps may be subtracted from various aspects of the invention without departing from the scope of the invention. Singular elements/steps imply plural elements/steps and vice versa. Some steps may be performed serially, in parallel, in a pipelined manner, or in different orders than disclosed herein. Many other variations are possible which remain within the content, scope, and spirit of the invention, and these variations would become clear to those skilled in the art after perusal of this application.

What is claimed is:

1. A method of forming a composition comprising the steps of:
combining a first group of constituents;
then combining the first group of constituents with a second group of constituents;
and then combining the combined first and second group of constituents with a third group of constituents to form the composition.

2. The method of claim 1 wherein,
the first group of constituents consists of,
a monomer,
a wetting agent,
a flouro-monomer,
a first solvent,
a second solvent,
a surfactant,
an additive for adding hardness,
water,
and a flouro-chemical;
the second group of constituents consists of,
a prepolymer,
a first catalyst,
a surfactant,
a solvent,
water,
and a second catalyst;
and the third group of constituents consists of,
a catalyst,
a monomer,
and a graft initiator.

3. The method of claim 2 further comprising the step of:
applying the composition to a portion of a stainless-steel blade.

4. The method of claim 3 wherein:
the stainless-steel blade is devoid of an aperture formed therein.

5. The method of claim 1 wherein,
the first group of constituents consists of,
a monomer,
a wetting agent,
a first flouro-monomer,
a solvent,
water,
and a second flouro-monomer;
the second group of constituents consists of,
a prepolymer,
a first catalyst,
a surfactant,
a flouro-chemical,
a second catalyst,
and a solvent;
and the third group of constituents consists of,
a catalyst,
a graft initiator,
water.

6. The method of claim 5 further comprising the step of:
applying the composition to a portion of a stainless-steel blade.

7. The method of claim 6 wherein:
the stainless-steel blade is devoid of an aperture formed therein.

8. The method of claim 1 wherein,
the first group of constituents consists of,
a monomer,
a wetting agent,
a first solvent,
a second solvent,
and a flouro-chemical;
the second group of constituents consists of,
a prepolymer,
a first surfactant,
a monomer,
a first catalyst,
a second surfactant,
water,
a second catalyst,
and a solvent;
and the third group of constituents consists of,
a catalyst,
and a graft initiator.

9. The method of claim 8 further comprising the step of:
applying the composition to a portion of a stainless-steel blade.

10. The method of claim 9 wherein:
the stainless-steel blade is devoid of an aperture formed therein.

11. The method of claim 1 wherein,
the first group of constituents consists of,
1 parts by weight of a monomer,
0.5 parts by weight of a wetting agent,
1 parts by weight of a flouro-monomer,
5 parts by weight of a first solvent,
10 parts by weight of a second solvent,
0.5 parts by weight of a surfactant,
0.75 parts by weight of an additive,
58.75 parts by weight of water,
and 62.5 parts by weight of a flouro-chemical;
the second group of constituents consists of,
20 parts by weight of a prepolymer,
2 parts by weight of a first catalyst,
0.5 parts by weight of a surfactant,
5 parts by weight of a solvent,
71.5 parts by weight of water,
and 1 parts by weight of a second catalyst;
and the third group of constituents consists of,
0.1 parts by weight of a catalyst,
0.1 parts by weight of a monomer,
and 0.1 parts by weight of a graft initiator.

12. The method of claim 1 wherein,
the first group of constituents consists of,
1.5 parts by weight of a monomer,
1 parts by weight of a wetting agent,
1 parts by weight of a first flouro-monomer,
5.5 parts by weight of a solvent,
62.5 parts by weight of water,
and 2 parts by weight of a second flouro-monomer;
the second group of constituents consists of,
20 parts by weight of a prepolymer,
2 parts by weight of a first catalyst,
0.5 parts by weight of a surfactant,
62.5 parts by weight of a flouro-chemical,
1 parts by weight of a second catalyst,
and 4.5 parts by weight of a solvent;
and the third group of constituents consists of,
0.1 parts by weight of a catalyst,
0.1 parts by weight of a graft initiator,
and 65 parts by weight of water.

13. The method of claim 1 wherein,
the first group of constituents consists of,
1 parts by weight of a monomer,
0.5 parts by weight of a wetting agent,
5.5 parts by weight of a first solvent,
10 parts by weight of a second solvent,
and 60 parts by weight of a flouro-chemical;
the second group of constituents consists of,
20 parts by weight of a prepolymer,
0.5 parts by weight of a first surfactant,
0.5 parts by weight of a monomer,
2 parts by weight of a first catalyst,
0.5 parts by weight of a second surfactant,
72 parts by weight of water,
1 parts by weight of a second catalyst,
and 4.5 parts by weight of a solvent;
and the third group of constituents consists of,
0.1 parts by weight of a catalyst,
and 0.1 parts by weight of a graft initiator.
